(19) United States
(12) Patent Application Publication
(10) Pub. No.: US 2026/0081996 A1
(43) Pub. Date: Mar. 19, 2026

(54) CALL SCRIPT COMPLIANCY BASED ON SPEECH-RECOGNITION WORD-LATTICES AND NATURAL LANGUAGE UNDERSTANDING ABSTRACTION

(71) Applicant: Applications Technology (AppTek), LLC, McLean, VA (US)

(72) Inventors: Christian Dugast, Bad Honnef (DE); Jintao Jiang, McLean, VA (US)

(21) Appl. No.: 19/330,122

(22) Filed: Sep. 16, 2025

Related U.S. Application Data
(60) Provisional application No. 63/695,230, filed on Sep. 16, 2024.

(51) Int. Cl. H04M 3/51; G10L 25/51; H04M 3/42

(52) U.S. Cl. CPC H04M 3/5175; G10L 25/51; H04M 3/42221; H04M 2201/405

(57) ABSTRACT

An apparatus and method for automatically determining compliancy by each of a plurality of agents to one of a plurality of call scripts includes storing at least one script and speech audio corresponding to what the agent has said during a call, and program instructions for an ASR engine and a script compliancy program that performs a comparison between what an agent has said during a call with what the agent should have said and produces reports including compliance information, time stamps, snippets and best sequences of words for agents and corresponding scripts and calls.

### CROSS REFERENCE TO RELATED APPLICATIONS

This patent applications claims priority to and incorporates by reference herein U.S. Provisional Patent Application No. 63/695,230, entitled, “Call Center Agent-Script Compliancy Based On Speech-Recognition Word-Lattices And Natural Language Understanding Abstraction,” filed on Sep. 16, 2024.

### FIELD OF THE INVENTION

The present invention relates generally to outbound call center analytics and more particularly, to a method of verifying how call center agents adhere to the script (or script-sub-parts) they need to follow according to the campaign they are calling customers for.

### BACKGROUND OF THE INVENTION

Call center analytics of the type “script adherence” (also called “script compliancy”) need to rely on a precise Automatic Speech Recognition (ASR) system. ASR systems are typically trained on a wide variety of calls to enable them to become script independent. While this training method allows for an easy management of the ASR system, recognition precision may suffer on certain scripts: did the agent announce the expected price (nineteen dollars seventy) or did she announce a lower price (nineteen dollars seventeen)?

There is a need to be able to work with only one generic ASR system (ease of management) while, knowing a priori what the call is about (based on the script), being able to dynamically adapt and increase recognition precision during the automatic processing of a call.

Interpolating a generic Language Model (LM) of the ASR system with the script of a call, while having the advantage of a straightforward implementation, does not perform as expected because what is not part of the script will frequently be badly recognised and will negatively impact analytics.

There is a need accordingly to first detect when (time stamped position) the script may have been followed by the agent during the call and to adapt the ASR output to the script only on the detected part of the call, not impacting ASR results on non-scripted parts of the call. There is a further need to measure compliancy with a script where the language may have significant variation to a script in terms of what portions of a script are used, when they are used and how closely they correspond to the script.

### SUMMARY OF THE INVENTION

According to an embodiment of the invention, two State of the Art (SotA) technologies may be implemented for script compliance verification. The first extends an Automatic Speech Recognition (ASR) SotA system which produces from an audio file the best sequence of words together with a confusion network (or word lattice). The second extends a Natural Language Understanding (NLU) SotA system which abstracts the meaning of expressions. A three-pass process may be implemented.

At a high level, an embodiment of the invention is first to position the script within the call. Second, a language model proposed by the script is only enforced on that part of the call where the script has been positioned. This may be done by aligning a word sequence as defined by the script to rescore/re-order a confusion network (or word lattice) produced by the ASR system only on parts of the call where the agent addressed the script. In a third step, the scripts are re-scored on the resolved forms (not on the spoken forms).

Implementing a method to reduce the search space within the confusion networks (or word lattice) has advantages. Reducing the search space size by an order of magnitude of 3 may enable keeping a low real time factor (below 0.1). This is done by concentrating the search on non-noisy data (i.e., focusing on substitutions as opposed to insertions and deletions which, with respect to the script, is noise), so focusing on substitutions obtained by aligning the confusion networks (or word lattice) with the script.

Also, in order to give call center agents some flexibility, there is a need to allow for equivalent/alternate expressions (e.g. “nineteen dollars and seventy cents” should be equivalent to “nineteen dollars and seventy”, or “nineteen dollars seventy” or even “nineteen seventy”) while being uncompromising on small errors (e.g. “nineteen dollars seventeen”). Resolving abstracted forms to their values in context as described herein below allows abstraction of meaning at its correct value.

According to an embodiment of the invention, script compliancy checker, comprises a memory and a processor. The memory stores program instructions, a script and speech data for performing a comparison of what an agent has said during a call with what the agent should have said according to the script. The processor, coupled to the memory executes the program instructions to process an input audio file containing a record of a call to create a compliancy report which illustrates between which time stamps the agent has followed the script, the agent's speech during these time stamps, and how the speech scores compared to the script. The memory may further store a best sequence of words spoken by an agent as compared to the script as decoded by the ASR engine. The memory may also store at least one confusion network (or word lattice) of a call and the processor may determine at least one position of the script within the call based on spoken forms. The processor may be configured to further execute program instructions to, based on spoken forms, define a best match between a snippet and script within the call.

According to some embodiments, the processor is configured to further execute program instructions to reformulate the snippet by looking only at substitutions between the script and the first best ASR output in order to create a new best-sequence-of-words within the time stamps of the snippet and/or a best match between the snippet and the script and a compliancy report. The processor may be configured to further execute program instructions to position the script within the call based on a resolved form of the reformulated snippet (abstracted tags and their values).

According to another embodiment of the invention, a method of determining script compliancy on a call, includes storing a script to be used during a call, recording speech data during the call by an agent, executing the program instructions to process an input audio file containing the speech data for the call to create a compliancy report which illustrates between which time stamps the agent has followed the script, what the agent said during these time stamps, and how speech of the agent scores compared to the script. The method may include storing a best sequence of words spoken by an agent as compared to the script as decoded by an ASR engine; creating and storing at least one confusion network for the call; and among other compliancy scoring techniques, determining a position of the script within the call and producing a compliancy report.

Processing the passes may use spoken or resolved forms of speech. For example, the first and second passes may be based on spoken forms while the last pass may be based on resolved forms.

### BRIEF DESCRIPTION OF THE FIGURES

The above described features and advantages will be more fully appreciated with reference to the below figures.

FIG. 1 depicts a flow diagram of a compliance system, according to an embodiment of the invention, which receives call center audio and a corresponding script that is meant to have been used by a call center agent, and a method to determine compliance with the script.

FIG. 2 depicts a functional block diagram of the same compliance system according to the same embodiment of the same invention. Both figures represent a sequence of processes according to an embodiment of the invention which are organised in 3 paths, which are each part are of embodiments of the invention.

FIG. 3 depicts a block diagram of a system according to an embodiment of the invention.

### DETAILED DESCRIPTION

According to embodiments of the present invention, a script compliancy method and system are provided that leverage ASR and NLU and additional processing to analyse and compare speech by an agent during a call with a script that the agent was supposed to use for the call. The system and methods may extend an ASR system to produce from an audio file of the call the best sequence of words together with a confusion network (or word lattice). The system and method may extend a Natural Language Understanding system to abstracts the meaning of expressions. A three-pass process may be implemented to produce various compliancy metrics and related data as described herein.

At a high level, an embodiment of the invention is first to position the script within the call. Second, a language model proposed by the script may be enforced on that part of the call where the script has been positioned. This may be done by aligning a word sequence as defined by the script to rescore/re-order a confusion network (or word lattice) produced by the ASR system only on parts of the call where the agent addressed the script. In a third step, the scripts are re-scored on the resolved forms (not on the spoken forms).

The below table of defined terms are provided to facilitate understanding illustrative embodiments of the present invention:

TABLE 1
Definitions.

| | |
|---|---|
| ASR | Automatic Speech Recognition system that automatically transcribes any |
| | recorded audio into the best possible sequence of words, best sequence |
| | according to its acoustic model and language model. |
| Language | A model used by the ASR engine which, given a sequence of spoken words, |
| Model | predicts the next word. |
| NLU | Natural Language Understanding system that based on a given context, |
| | automatically defines the meaning (abstracted form) of a sequence of |
| | words. (e.g. Input == “this is New York New York” in the context of indicating |
| | an address → output == “this is [CITY]<New-York> [STATE]<New-York>” |
| Confusion | Given the ASR best recognised sequence of words, the Confusion Networks |
| Networks (or | (or word lattice) contains, for each word, a list of scored alternative words. A |
| word lattice) | word is defined as a slot, each slot containing time stamped alternative arcs |
| | (or words). (e.g. if “seventy” is the best recognised arc within a slot, |
| | “seventeen”, “seven” can be alternative arcs stored in the corresponding |
| | slot). |
| Call | The recorded audio of a call between 2 human beings, typically a customer |
| | and a call center agent |
| Spoken form = | The sequence of spoken words as recognised by the ASR system (e.g., “we |
| Verbatim | will meet at twelve twenty-five”) |
| Abstracted/ | The output of an NLU system is an abstracted (annotated) form of the |
| Annotated | verbatim or ASR output (e.g., “we will [ACTION]<meet> at [NUMB]<twelve |
| form | twenty-five>. |
| Resolution/ | An abstracted word or expression can be resolved or can be attributed a |
| Resolved value | value: it is the computable (calculated) value meant by the abstraction in its |
| | context (e.g. “twelve twenty five” is a [NUMB] which can be resolved as |
| | “12:25 pm”, “US$ 12.25”, “12.25W” etc.) |
| Resolved form | The sequence of words in their resolved form as understood by the NLU |
| | system (e.g., the spoken form or verbatim “it will be at twelve twenty-five”, |
| | in case of a time context will be resolved as “it [MOD]<will be> at [TIME] |
| | <12:25 pm>” or in case of a price context “it [MOD]<will be> at |
| | [CURRENCY]<US$2.25>”) |
| Campaign | Each call falls under a campaign which defines the scope and content |
| | (product(s) to sell, costs, conditions . . . ) of the call to be made by each agent |
| Script | A call center agent must follow a script which defines details of the |
| | campaign. Some parts of the script are mandatory (e.g., price of a product) |
| Standard Script | A unique non interruptible phrase that must be spoken by the agent at some |
| | moment of the call. |
| Group Script | A sequence of Standard Scripts. Whereas the content between 2 Standard |
| | Scripts is free (not constrained by a script). |
| Trigger | Each Standard Script can contain up to three triggers (at the beginning, in |
| | the middle and at the end of a script) which are the most meaning full words |
| | of a script. Script positioning is based on trigger scoring. Meaningful words |
| | are NLU annotated/abstracted words, eventually long words. |
| Snippet | The sequence of words within a call that best fits a Standard Script, together |
| | with its position in the call. |
| Group Snippet | The sequence of snippets that best fits a Group Script |
| Position | Within a call, the position of an expression or sequence of words is defined |
| | by its time stamps, when it ends and when it finishes. It is typically defined |
| | in milliseconds. |

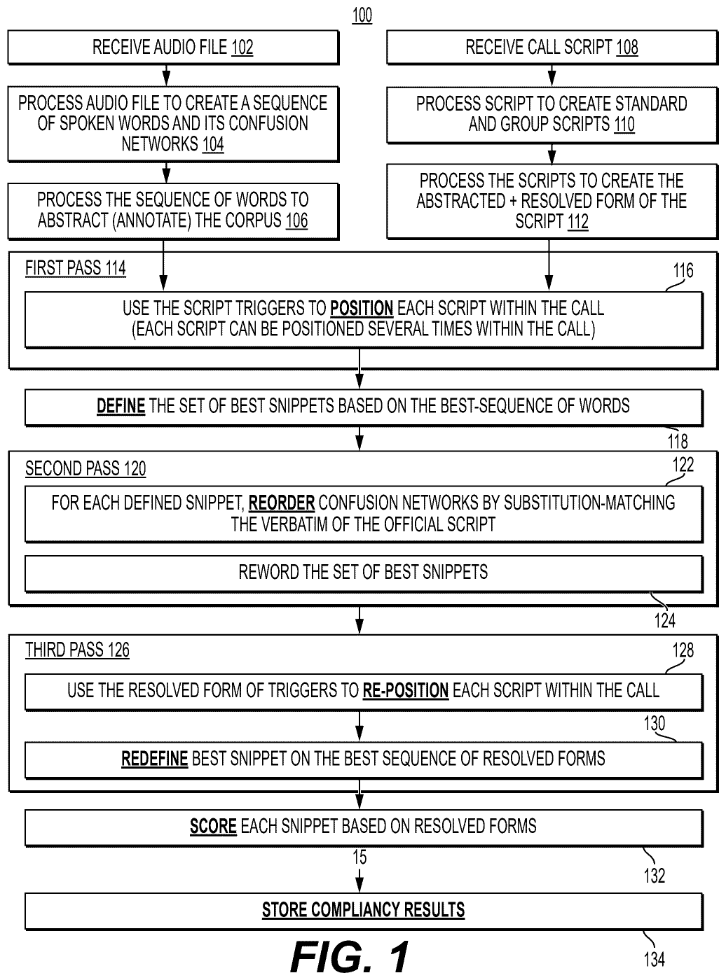

FIG. 1 depicts a flow diagram 100 of a compliance system, according to an embodiment of the invention, which receives call center audio and a corresponding script that is meant to have been used by a call center agent, and a method to determine compliance with the script. Referring to FIG. 1, before going into the first path of the invention, an audio file is received in 102 that reflects a call between an agent and a caller, typically a customer, prospective customer or subscriber. In 204, the audio file is processed through an ASR system which produces the verbatim, a spoken sequence of words, of the call as well as its confusion networks. In parallel in 108 the compliancy system and method receive a script reflecting what the agent is supposed to say at one or more points during the call. In 110, the script may be pre-processed and organised in a set of Standard Scripts and/or Group Scripts.

In 106, a NLU system processes the verbatim of the call to produce its abstracted form (through annotations). NLU is also applied to the script to also produce an abstracted form of the script in 112. In 114, a first pass is performed on the output produced in 106 and 112. The goal of the first pass is to find, within the call, the best position of each Standard Script (snippet), i.e., at which time stamp each Standard Script can be found. Positioning snippets is done in 2 steps: first finding a sequence of triggers related to the Standard Script, secondly, aligning and scoring the snippet around the triggers.

In 116, triggers within the script (up to three positioned at the beginning, middle and end of the script) are used to align and score the script around its triggers relative to the sequence of words in the call. According to an embodiment of the invention, triggers are not hardcoded, but they may be automatically selected outside of a list of functional words and with a length of more than 5 letters (typically more than 2 vowels). If words of more than 5 letters are not found in the script, the minimum number of letters may be decreased to 4, 3 and 2 until a trigger is identified. Functional words are less than 100 in number and are words like “he, she, . . . , after, before . . . the, a, on, at . . . ” They typically make up 50% of every document. Certain triggers may optionally be hard coded.

This alignment positions the script triggers relative to time stamps and word sequences in the call producing snippets that correspond to the script. In 118, the set of best snippets is identified based on the best sequence of words. The result of the first pass is a set of time-stamped (positioned) and scored best-snippets.

In a second pass 120, each snippet found is reworded according to what the script tells us should/could have been said by the agent. In 122, for example, the rewording process makes use of the confusion network, which contains for each word, alternative words that may have been pronounced by the agent. These alternative words are words that according to the general language model of the ASR system, do not fit optimally (because the ASR language model is general and does not know where which script can be pronounced by the agent). The invention uses the information provided by the first path of the invention (i.e., where the script has been spoken with the highest probability), to rescore the confusion network using the language model given by the script (strict sequence of words). This is done by aligning the script with all possible local sentences the confusion network proposes (see scoring method). In order to optimise computing power and memory usage the alignment is done only on substitutions (ignoring deletions and insertions which are noise). This allows to reduce the search space size by three orders of magnitude, from millions of alternatives to thousands per snippet. In 124, the set of best snippets is reworded. The result of the second path is an improved verbatim that has made use of the information provided by the script. After rewording, half of the ASR errors are corrected.

In 126, a third pass may process compliancy with a higher quality verbatim and is done on the resolved verbatim (NU+resolution). In 128, the resolved form of triggers is used to re-position each script within the call. In 130, the best snippets on the best sequence of resolved forms is redefined. In 132, each snippet is scored based on the resolved form. In 134, based on the scoring and data generated by passes 1-3, the compliancy results may be reported to a user and/or stored according to embodiments of the system and method.

With the usage of the confusion network, the rewording it allows and the comparison of resolved snippets with resolved scripts, the compliancy F1 score may be expected to improve from 70%-75% to exceed 90% (accuracy may be expected to move from 60% to above 80%).

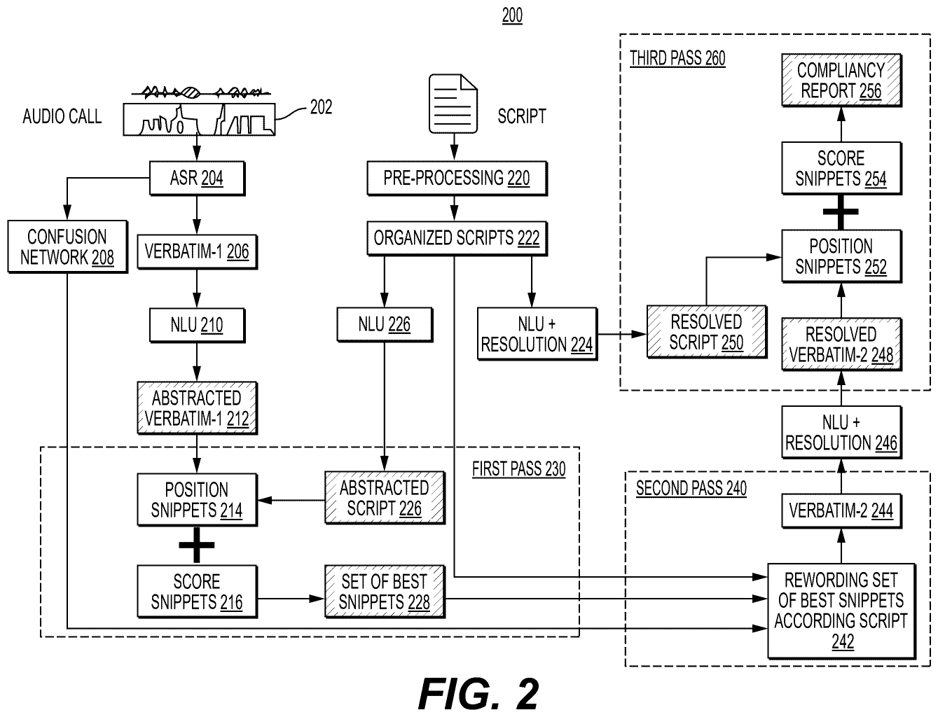

FIG. 2 depicts a functional block diagram 200 of the compliancy scoring system and method that may implement the method shown and described in FIG. 1. Referring to FIG. 2, an ASR system or engine 204 receives audio call data 202 and produces a verbatim transcript 206 and a confusion network or word lattice 208. A NLU 210 acts on the verbatim to produce an abstracted verbatim 212.

The preprocessor 220 receives one or more scripts and produces organized scripts 222, which are processed by NLU 226 to produce an abstracted script 226 and processed by NLU+Resolution 224 to produce a resolved script 250.

The position snippets block 214 and the score snippets block 216 receive the abstracted verbatim 212 and the abstracted script 226 and perform the first pass 230 script to produce the set of best snippets 228 with their accompanying data. The accompanying data may include, for example:
a score (f1) based on the edit distance score between the sequence of letters of the script and the sequence of letters of the best snippet;
a position of the beginning and the end of the snippet within the document/call (word number and time stamp) as well as a compactness score; and
a compactness score (how compact is the best snippet when it is a construct of sub-snippets: the more noise between each sub-snippet, the less compact it is).

In the second pass, block 242 rewords the set of best snippets according to respective scripts to produce a second verbatim 244. The NLU+resolution block 246 receives the second verbatim and produces a resolved second verbatim 248. Another set of position snippets and score snippets blocks, 252 and 254 in the third pass 260 receive the resolved second verbatim and the resolved script and process that data to produce the compliancy report 256 and accompanying data. Below is an illustrative script compliancy report according to an embodiment of the invention in a JSON file format.

### Example 1 Script Compliancy Report

```
  {
  “version”: 3,
  “minor”: 6,
  “patch”: 0,
  “codeTimeStamp”: “202404081152824”,
  “gitCommit”: “75118a4d0fc563eddf587ff5654d2ddc334ec7b3”,
  “RunningHead”: “ref: refs/heads/master”,
  “RunningCommit”: “5c1c6f2b42d759380841f5ff9a675eee1f4e4e60”
}, {
  “filename”: “010F7DBD-A75F-4A68-835F-93219A2472D4”,
  “confirmOrder”: [{
        “scriptCompliancy”: “partial”
        “level”: “ LOW score on free ”,
        “decision”: true,
        “spanIsTooLong”: false,
        “greyZone”: true,
        “could be negative”: false,
        “Positive scripts that could be negative”: “”,
        “f1”: 86.50143262372364,
        “decisionScore”: 86.50143262372364,
        “compactedWeightedScore”: 86.50143262372364,
        “compactness”: 1,
        “Official Script”: “ [ _AND_ let's confirm your order today
_AND_ you will be receiving one bottle of mag blue for only _AND_ nine
dollars and ninety five cents _AND_ along with a free bottle of B twelve
energy berry melts plus free shipping _AND_ to continue your benefits in
about four weeks we will ship you two bottles of mag blue _AND_ every
two months for the same low price of _AND_ twenty nine dollars and
ninety five cents _AND_ each _AND_ two bottles of B twelve energy berry
melts at _AND_ seventeen dollars and ninety five cents _AND_ each _AND_{—}
free shipping. ]”,
        “Official Tag Script”: “[ _AND_ let 's <ACTION> your
<ACTION> <DATE> _AND_ <PERS> will be <ACTION> <UNIT> of mag blue
<NOTUSEDTAG> _AND_ <CURR> _AND_ along with a free bottle of <SCOPE>
berry melts plus <SCOPE> _AND_ to continue your benefits in about <UNIT>
<PERS> <MODALITY> ship <PERS> <UNIT> of mag blue _AND_ every <UNIT> for
the same low <SCOPE> of _AND_ <CURR> _AND_ each_AND_ <UNIT> of <SCOPE>
berry melts at _AND_ <CURR> _AND_ each _AND_ <SCOPE> ]”,
        “Call Snippet Spoken”: “ _AND_ just to confirm today _AND_{—}
you going be receiving the one struggle bottle of glue _AND_ nine ninety
five _AND_ along with the free bottle vinge then _AND_ to continue your
benefits in about four weeks we will ship you two bottles of the maglev
_AND_ every two months for the low price of _AND_ twenty nine ninety
five _AND_ each _AND_ two bottles of the twelve energy emails at _AND_{—}
seventeen ninety five _AND_ each _AND_ free shipping state”,
        “Call Snippet NLU”: “ _AND_ just to confirm today _AND_ you
going be receiving the one struggle bottle of glue _AND_ 9.95 _AND_{—}
along with the free bottle vinge then _AND_ to continue your benefits in
about 4 Weeks we will ship you 2 bottles of _AND_ every 2 Months for the
low price _AND_ 29.95 _AND_ each _AND_ 2 bottles of the 12 energy emails
_AND_ 17.95 _AND_ each _AND_ free shipping”,
        “Call Snippet Tagged”: “ _AND_ just to <MODALITY> <DATE>
_AND_ <PERS> going be <ACTION> the <NOTUSEDTAG> struggle bottle of glue
_AND_ <CURR> _AND_ along with the free bottle vinge then _AND_ to
continue your benefits in about <UNIT> <PERS> <MODALITY> ship <PERS>
<UNIT> of the maglev _AND_ every <UNIT> for the low <SCOPE> of _AND_{—}
<CURR> _AND_ each _AND_ <UNIT> of the <CURR> energy emails at _AND_{—}
<CURR> _AND_ each _AND_ <SCOPE> state”,
        “StartIndex”: 681,
        “LastIndex”: 742,
        “TimeStampStart”: 469.2,
        “TimeStampEnd”: 488.46,
        “fileName”: “010F7DBD-A75F-4A68-835F-93219A2472D4”,
        “manualComment”: “noComment”
      }
  ]
    }
```

In this example of a script compliancy report on just one script for one call, the illustrative script used is a sequence of 10 subscripts (each subscript is delimited by the _AND_separator). The call is partially compliant on this script because the sub-script named “free” has a low score. But the f1 score of 86.5 (out of 100) and the compactness score of 1 (interval [0-1] so maximum compaction) makes it a good candidate for being compliant hence the decision being “true”.

The confusion networks identified above are each a two-dimensional representation of recognised word sequences together with their alternatives. It is also a word lattice as words can be overlapping in time. The formalism followed in this invention is to consider a sequence of slots, each slot containing arcs (made of a word, a score and begin-end timestamp pair). According to an embodiment of the invention, any conventional or other method to reduce the size of the search space within the confusion networks (or word lattice) may be used when looking for a script adapted interpretation of the spoken sentence. Conventional techniques may enable reduction of the size of the search space by up to three orders of magnitude.

### Example 2-Script

Consider an example of an AND conjuncted script group stored in a JSON file, for example as shown below. A sequence of phrases may be given (e.g., “let's confirm your order today” is followed by “you will be receiving one bottle of mag blue for only”) any other phrase may appear between those 2 phrases. This allows for interruptions, hesitations and/or repetitions, either on the agent side or on the caller side. To note the property “CONFIDENCE” for each phrase which can have 2 different values, either “STANDARD” or “HIGH”. The value “STANDARD” indicates the phrase can be different in wording (e.g., the word “price” has the same meaning as “amount”, even “sum” if followed by a number), the value “HIGH” meaning that the exact meaning of the phrase is expected. In the example provided in the file “script-example.json”, all money amounts are set with a “HIGH” confidence: it is not any price that is expected, not even a price level (e.g. $20 for $17.95) but the exact price (e.g., US$17.95).

```
{
  “confirmOrder”: {
    “OPERATION”: “AND”,
    “SCRIPTS”: {
      “confirm”: {
        “TEXT”: “let's confirm your order today”,
        “CONFIDENCE”: “STANDARD”
      },
      “receiving”: {
        “TEXT”: “you will be receiving one bottle of mag blue
for only”,
        “CONFIDENCE”: “STANDARD”
      },
      “995”: {
        “TEXT”: “nine dollars and ninety five cents”,
        “CONFIDENCE”: “HIGH”
      },
      “free”: {
        “TEXT”: “ along with a free bottle of B twelve energy
berry melts plus free shipping ”,
        “CONFIDENCE”: “STANDARD”
      },
      “benefits”: {
        “TEXT”: “to continue your benefits in about four weeks
we will ship you two bottles of mag blue”,
        “CONFIDENCE”: “STANDARD”
      },
      “samelow”: {
        “TEXT”: “every two months for the same low price of ”,
        “CONFIDENCE”: “STANDARD”
      },
      “2995”: {
        “TEXT”: “twenty nine dollars and ninety five cents”,
        “CONFIDENCE”: “HIGH”
      },
      “each29”: {
        “TEXT”: “each”,
        “CONFIDENCE”: “STANDARD”
      },
          “b12”: {
        “TEXT”: “ two bottles of B twelve energy berry melts
at”,
        “CONFIDENCE”: “STANDARD”
      },
      “1795”: {
        “TEXT”: “seventeen dollars and ninety five cents”,
        “CONFIDENCE”: “HIGH”
      },
          “each17”: {
        “TEXT”: “ each”,
        “CONFIDENCE”: “STANDARD”
      },
      “shipping”: {
        “TEXT”: “free shipping.”,
        “CONFIDENCE”: “STANDARD”
      }
    }
  }
}
```

### Example 3-Compliancy Result

Consider an example JSON file that includes data from a call, including call id “010F7DBD-A75F-4A68-835F-93219A2472D4.” The JSON file indicates this call is partially compliant to the script defined in another file “Official Script”. The detected snippet occurs between the time stamps 469.2 seconds and 488.13 seconds (or between the 810th and the 882nd word of the ASR output). The score of this snippet is 73.061 which is reasonably high given the partial compliancy detected. A snippet scored above 70% will generally be accepted as compliant. Those snippets scored between 60% and 70% are put in a grey zone and may need be verified manually by a human analyst.

### Scoring Methods

According to one or more embodiments of the invention, any scoring method can be used to select the best snippet relative to a Standard Script, independently of the representation form of a word, e.g., a sequence of letters or a vector in a multi-dimensional space derived from a pre-trained large language model.

A letter based edit distant may outperform, as much in terms of CPU time as in terms of performances (F1-scores), any vector based embedding distance, specifically for aligning the call best resolved form of the audio with the resolved form of the script, but also for aligning spoken forms to each other.

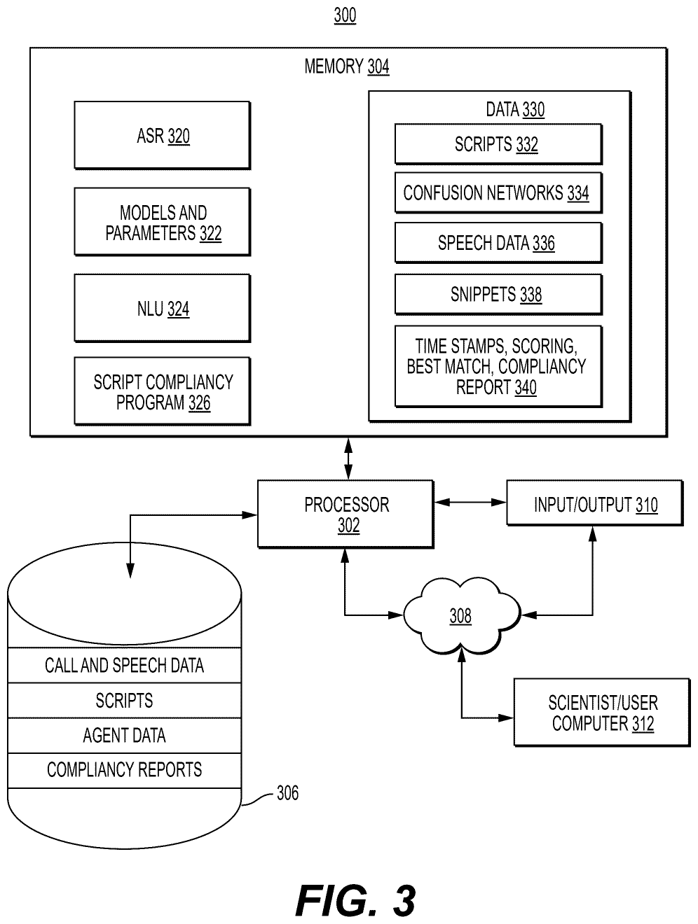

FIG. 3 depicts an illustrative system 300 that may be used for monitoring agent compliance to a script on a call, such as an outbound or inbound call, according to an embodiment of the present invention. Referring to FIG. 3, a processor 302, which may comprise one or more central or distributed CPUs or GPU's is coupled to a memory 304, databases 306, networks 308, input/output devices 310 and computers 312 operated by data scientists and/or users.

The memory stores ASR software 320, NLU software 324, models and parameters 322 that may be custom or trained for each, and a script compliancy program 326. The ASR and NLU software, models and script compliancy program may each include program instructions that, when executed by the processor, implement the ASR, NLU, models and the script compliancy programs respectively, including the first, second and third passes described herein, the position snippet and score snippet blocks and the methods and processes illustrated and described with reference to FIGS. 1 and 2. Each model may have associated parameters 322 stored in memory. The memory may also include other software and libraries such as Python, TensorFlow, Pytorch and other software known in the art including networking software. The memory may also store data 328, including but not limited to data for one or more scripts 332, confusion networks 334, data for calls 336, agents, compliancy reports and scoring data 340, verbatims, abstracted verbatims, resolved verbatims, resolved scripts and sets of snippets 338 and best snippets. In general, the software and libraries include program instructions that when executed by a processor to take certain actions including implementing passes 1-3 described herein on determining agent compliancy with calls based on specific scripts.

The GPU may be comprised of multiple GPU chips with hundreds, thousands or tens of thousands or cores, depending on the size. The memory may also range from several Gigabytes to tens or hundreds of Gigabytes. There is a trade-off between the processing power of the GPUs and size of the memory and the cost of the equipment used to implement the invention. Techniques according to the present invention enable more efficient configuration of specific hardware for deployment of resources for script compliancy determinations on a call-by-call basis.

The input/output devices coupled to the processor may include keyboards, displays, speakers, microphones, and mouse devices to enable data scientists and users to interact with the system and methods described herein for script compliancy. This may include launching the script compliancy program to run on one or a large number of calls for which call data is available. The user computer may also facilitate designing scripts for agents to use or enable users to upload such scripts to the database or memory. The user computer may also be used to make adjustments to the compliancy scoring parameters or ASR and NLU system parameters to optimize performance, results or make changes for different operating environments. The system may also be implemented in a cloud-based environment where users interact with the processor, database and associated memory via the cloud, the internet or networks.

While particular implementations have been shown or described herein, it will be understood that changes may be made to those embodiments without departing from the spirit and scope of the present invention.

What is claimed is:

1. A script compliancy checker, comprising:
a memory for storing at least one script for an agent to follow in a call and speech audio corresponding to what the agent has said during the call, program instructions for an ASR engine and a script compliancy program for performing a comparison of what an agent has said during a call with what the agent should have said according to the script;
a database for storing reports; and
a processor coupled to the memory for executing the program instructions to process automatically an input audio file containing a record of a call, based on ASR, to create a compliancy report which illustrates between which time stamps the agent has followed the script, what the agent said during these time stamps, and how speech of the agent scores compared to the script.

2. The system according to claim 1, wherein the processor executes the compliancy program to determine a best sequence of words spoken by an agent as compared to the script as decoded by the ASR engine and stores in the memory the best sequence.

3. The system according to claim 1, wherein the processor executes the ASR engine to create a verbatim sequence of words and at least one confusion network corresponding to the audio in the call and stores the sequence data and the at least one confusion network in the memory.

4. The system according to claim 2, wherein the processor further executes program instructions to, based on the speech audio and a corresponding one of the at least one script, to determine at least one position of the corresponding script within the call.

5. The system according to claim 4, wherein the processor is configured to further execute the program instructions to, based on spoken forms, define at least one snippet as a best match sequence of spoken words to the at least one script within the call and its position within the call.

6. The system according to claim 5, wherein the processor is configured to further execute the program instructions to reformulate the at least one snippet based on substitutions between the at least one script and a first best ASR output in order to create a new best-sequence-of-words within time stamps associated with the at least one snippet.

7. The system according to claim 6, wherein the processor is configured to further execute the program instructions to produce at least one resolved form of the reformulated snippet including abstracted tags and their values.

8. The system according to claim 7, wherein the processor is configured to further execute the program instructions to, based on the at least one resolved form, position the script within the call.

9. The system according to claim 8, wherein the processor is configured to further execute program instructions to, based on the at least one resolved form, define the best match between the snippet and script within the call.

10. The system according to claim 9, wherein the processor is configured to further execute program instructions to produce a compliancy report and store the compliancy report in the database associated with a particular agent.

11. A method of determining script compliancy on a call, comprising:
storing at least one script to be used for determining automatically compliancy of at least one agent during at least one call;
recording speech data during one of the at least one call by one of the at least one agents and storing it in a memory;
executing program instructions stored in the memory, including those corresponding to an ASR engine and a script compliance program, to process an input audio file including the speech data for the one of the at least one calls to create a compliancy report, which illustrates between which time stamps the one of the least one agent has followed the at least one script, what the agent said during these time stamps, and how speech of the agent scores compared to the script.

12. The method according to claim 11, further comprising:
storing a best sequence of words spoken by an agent as compared to the script as decoded by the ASR engine.

13. The method according to claim 11, further comprising:
creating and storing at least one confusion network for the call based on the ASR engine output.

14. The method according to claim 12, further comprising:
executing the program instructions to, based on the speech data and a corresponding one of the at least one script to determine at least one position of the corresponding script within the call.

15. The method according to claim 14, further comprising:
executing the program instructions to, based on the speech data, determine a snippet as a best match between the speech data the at least one script for the at least one call.

16. The method according to claim 15, further comprising:
executing the program instructions to reformulate the snippet based on substitutions between the at least one script and first best ASR output in order to create a new best-sequence-of-words within time stamps associated with the at least one snippet.

17. The method according to claim 16, further comprising:
executing the program instructions to produce at least one resolved form of the reformulated snippet including abstracted tags and their values.

18. The method according to claim 17, further comprising:
executing the program instructions to, based on the at least one resolved form, position the script within the call.

19. The method according to claim 18, further comprising:
executing the program instructions to, based on at least one resolved form, define the best match between at least one of the snippets and the at least one reformulated snippet, and the script within the call.

20. The method according to claim 19, further comprising:
executing the program instructions to produce a compliancy report and store the compliancy report in a database associated with a particular agent.
